(19) United States
(12) Patent Application Publication
(10) Pub. No.: US 2014/0226676 A1
(43) Pub. Date: Aug. 14, 2014

(54) PROPORTIONAL SCHEDULING IN COMMUNICATIONS SYSTEMS

(71) Applicant: QUALCOMM INCORPORATED, San Diego, CA (US)

(72) Inventors: Hassan Kaywan Afkhami, Ocala, FL (US); Purva R. Rajkotia, Orlando, FL (US)

(73) Assignee: QUALCOMM INCORPORATED, San Diego, CA (US)

(21) Appl. No.: 13/767,712

(22) Filed: Feb. 14, 2013

(51) Int. Cl. H04L 12/56

(52) U.S. Cl. CPC H04L 47/6215
USPC 370/412

(57) ABSTRACT

Systems, methods and computer-readable media proportionally schedule packet transmission on a network. A node maintains a plurality of buffers configured to store packets to be transmitted by the node on a network. Each of the buffers may have a buffer priority and a buffer length. The node receives one or more channel access parameters. The channel access parameters may be determined in accordance with a link quality between the transmitting node and one or more receiving nodes. The node selects packet to be transmitted from a buffer based on the channel access parameters, the buffer priority of the buffer, the buffer length of the buffer and a deprivation factor associated with the packet.

### BACKGROUND

Embodiments of the inventive subject matter generally relate to the field of communications systems and, more particularly, to scheduling packet transmission in communications systems.

The scheduling algorithm used in scheduling packet transmission in current powerline communications networks is typically based on traffic priorities. The network traffic with the highest priority will generally get the first opportunity for time on a powerline communications network for data packet transmission. There can be instances wherein network traffic with medium priority or low priority may wait a considerable amount of time before being transmitted on the network. This can result in an unfair scheduling policy wherein some particular types of network traffic are disadvantaged over other types of network traffic. With the explosion of varying home networking devices, with various different applications providing network traffic, it is desirable to avoid effectively disenfranchising certain applications from network use as can happen using current packet transmission scheduling algorithms.

### SUMMARY

Various embodiments are disclosed for proportionally scheduling packet transmission on a network. A node maintains a plurality of buffers configured to store packets to be transmitted by the node on a network. Each of the buffers may have a buffer priority and a buffer length. The node receives one or more channel access parameters. The channel access parameters may be determined in accordance with a link quality between the transmitting node and one or more receiving nodes. The node selects a packet to be transmitted from a buffer based on the channel access parameters and one or more of the buffer priority of the buffer, the buffer length of the buffer and a deprivation factor associated with the packet.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram illustrating a system for proportionally scheduling packet transmission in a communications system.

FIG. 2 is an example block diagram illustrating a node in a system for proportionally scheduling packet transmission in a communications system.

FIG. 3 is a flow diagram illustrating example operations for proportionally scheduling packet transmissions.

FIG. 4 is a flow diagram illustrating example operations for determining channel access parameters used in proportionally scheduling packet transmissions.

FIG. 5 is an example block diagram of one embodiment of an electronic device including a mechanism for proportionally scheduling packet transmissions in a communications network.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to powerline communications networks, the inventive subject matter may be applied to other types of wired and wireless network communications technologies. In other instances, well-known instruction instances, protocols, structures and techniques have not been shown in detail in order not to obfuscate the description.

The term “based on” is used in the specification and claims to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

Various embodiments include systems, methods and machine readable media for scheduling packet transmission on a network. As packets are received for transmission, they are placed in one of multiple buffers, where each buffer has a different priority. Packets may be placed in a buffer according to traffic type, with video and VOIP packets being placed in higher priority buffers while other types of packets that are not as time sensitive (e.g., email, file transfer) may be placed in lower priority buffers. Packets may be timestamped with a time of arrival. In addition, a link quality may also be used determine channel access parameters to control transmission of packets on a node relative to other nodes. For example, the channel access parameters may include a channel access duration that may be increased between nodes having a higher quality link and decreased between nodes having a lower link quality, thereby favoring nodes that are more likely to have successful packet transmission.

During a transmission cycle, a scheduler selects a packet to be transmitted based on the channel access parameters and one or more of buffer priority, buffer length, and a deprivation factor associated with a packet. The deprivation factor is determined based on the time of arrival timestamp, and may be increased with each transmission cycle that a packet is not selected for transmission. Weightings may be applied to the channel access parameters, the buffer priority, buffer length and deprivation factor in order to tune transmission of packets to desired characteristics. The combination of factors allows for priority based transmission, while still providing for eventual transmission of low priority packets as the deprivation factor increases.

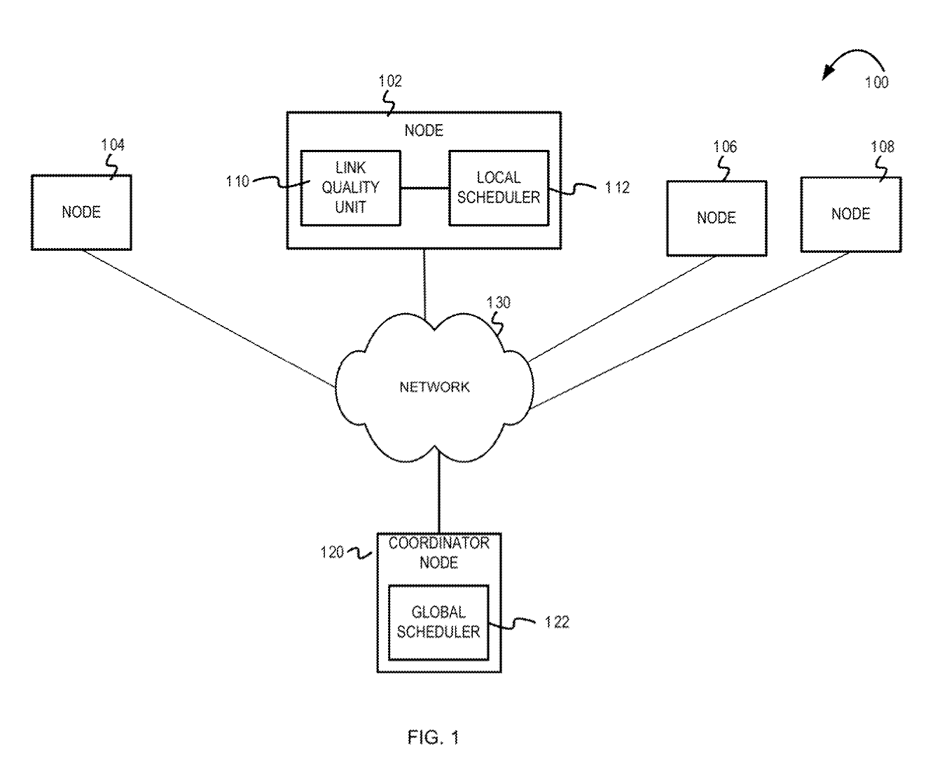

FIG. 1 is an example block diagram illustrating a system 100 for proportionally scheduling packet transmission in a communications system. In some embodiments, system 100 includes one or more nodes (e.g., nodes 102-108) and a coordinator node 120 communicably coupled by network 130. In some embodiments, network 130 may be powerline communications network. However, the embodiments are not limited to powerline communications networks, and in alternative embodiments, the network may be a wired network (e.g., an Ethernet interface), a wireless network (e.g., a WLAN interface, a BLUETOOTH® (Bluetooth) interface, a WiMAX interface, a ZigBee® interface, a Wireless USB interface, etc.) or a hybrid network including a combination of two or more wired or wireless networking technologies.

In some embodiments, coordinator node 120 coordinates the transmission of network packets between nodes in network 130. In some embodiments, coordinator node 120 may be any node of the network (e.g., 104, 106 or 108) and/or configured to handle both local and global scheduling, or alternatively a dedicated node for global scheduling. The coordinator node 120 may include a global scheduler 122 that determines one or more channel access parameters that may include channel access opportunities, channel access durations and channel access priorities for nodes 102-108 in network 130. Coordinator node 120 may communicate the channel access parameters for a node in network 130 using ordinary network packets. Alternatively, the channel access parameters may be data that is included as part of a beacon signal transmitted by coordinator node 120 on network 130.

Nodes 102-108 may include any of various types of network attached devices. Such devices include personal computers, server computers, laptop computers, tablet computers, music players, phones, televisions, video players, home appliances, or any other type of network attached device. The embodiments are not limited to any particular node type.

In some embodiments, node 102 includes a link quality unit 110 and a local scheduler 112. Link quality unit 110 determines a quality of a link between the node and other nodes on network 120. Generally speaking, the link quality is a measure of how well packets can be transmitted between the transmitting node and receiving node. Links with a higher link quality value typically have a higher probability of successfully carrying a packet compared to links having a lower link quality. Various types of measurements may be used to determine link quality. In some embodiments, a signal-to-noise ratio (SNR) may be used to determine link quality. In alternative embodiments, packet throughput may be used to determine link quality. For example, an actual packet throughput may be compared to an expected packet throughput to determine link quality. Node 102 may send link quality data determined by link quality unit 110 to coordinator node 120 for use by coordinator node 120 in determining channel access parameters for the various nodes in network 130.

Local scheduler 112 schedules transmission of packets from network node 102. As will be further described below, local scheduler 112 may use some or all of link quality data, channel access data received from coordinator node 120, buffer priority, buffer length and packet deprivation data to determine how packets are transmitted (e.g., which packets to transmit during a transmission cycle).

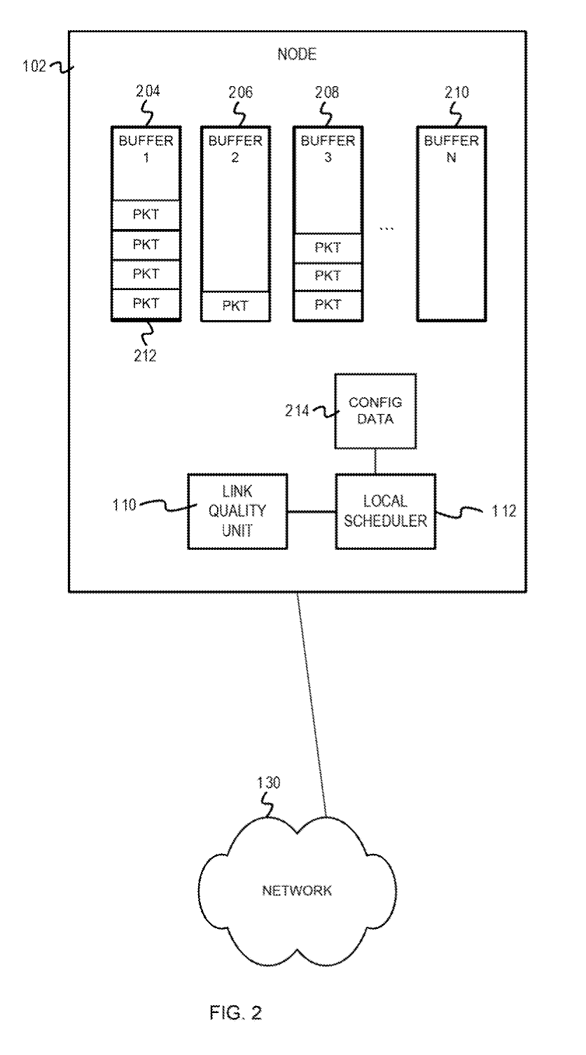

FIG. 2 is an example block diagram illustrating further details of a node 102 in a system for proportionally scheduling packet transmission in a communications system. In addition to link quality unit 110 and local scheduler 112 described above, node 102 may include packet transmission buffers 206-210 and configuration data 214. Packet transmission buffers 206-210 store packets from various sources on node 102 such as applications, services, daemons etc. for transmission on network 130. Each buffer 206-210 may have a priority associated with the buffer such that packets in a higher priority buffer are transmitted before packets in a lower priority buffer, all other factors being equal. As an example, packet types having VOIP (Voice over IP) data, video data or audio data may be placed in a high priority buffer because such data may be sensitive to transmission latency. Packet types having email data may be placed in a low priority buffer because such data is typically not sensitive to transmission latency. Node 102 may place a packet in a buffer based on inferring a priority from the packet type, from the application that provided the data in the packet, or by reading a priority in the packet data. Although four buffers are illustrated in the example node 102 shown in FIG. 2, those of skill in the art having the benefit of the disclosure will appreciate that more or fewer buffers may be maintained by a node and that such configurations are within the scope of the inventive subject matter.

In addition to a buffer priority, each buffer has a buffer length associated with the buffer. In the example illustrated in FIG. 2, buffer 204 contains four packets and therefore has a buffer length of four. Buffer 206 has a buffer length of one, buffer 208 has a buffer length of three and buffer 210 has a buffer length of two. As will be described below, buffer length may be used by local scheduler 112 to determine which packet will be transmitted by node 102.

Configuration data 214 stores data used by node 102 to schedule packet transmission. Configuration data 214 may store buffer priorities associated with buffers 204-210. Further, configuration data 214 may store channel access parameters received from global scheduler 122 of coordinator node 120. Such channel access parameters may include channel access opportunities, channel access duration, channel access priority or other channel access parameters for the network links accessible by node 102.

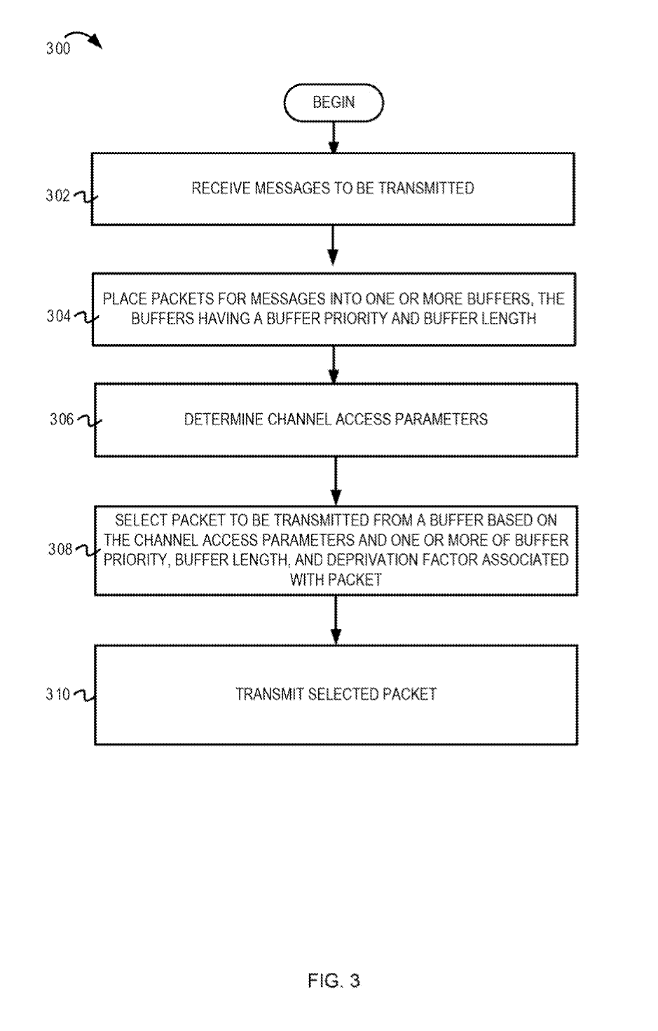

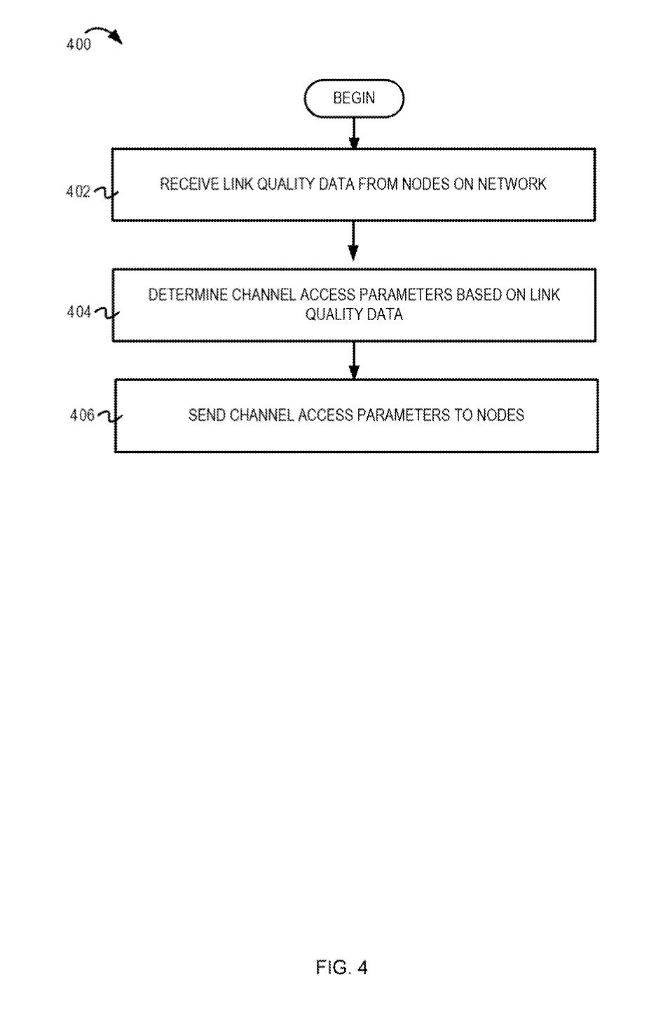

Further details on example operation of system 100 and node 102 are provided below with reference to FIGS. 3 and 4.

FIG. 3 is a flow diagram illustrating example operations in a method 300 for proportionally scheduling packet transmissions. In some embodiments, some or all of the operations described in method 300 may be performed at a MAC (Media Access Control) layer of a network stack provided on node 102. Method 300 begins at block 302 by receiving one or more messages to be transmitted over a network. The messages may include information such as message type, message source etc.

At block 304, packets for the messages received at block 302 are placed into one or more buffers, where each of the buffers may have a priority associated with the buffer. Node 102 may select a buffer for a packet based on priority information in the packet or on priority information determined according to the message type or message source. As packets are placed in a buffer, the buffer length associated with the buffer is incremented.

At block 306, node 102 determines channel access parameters for links associated with node 102. The channel access parameters may be determined locally according to a link quality determined by node 102, or the channel access parameters may be received from a global schedule 122 of a coordinator node 120. As noted above, channel access parameters may include a channel access opportunity, a channel access duration or a channel access priority. Channel access parameters may change over time and can be influenced by external transient events. For example, in a powerline communications network, an electric appliance or other device may be plugged into a power line carrying network traffic for the node. The appliance or other device may introduce noise into a segment of the powerline that can adversely affect the link quality associated with the network segment associated with the powerline segment. Similarly, a device that was causing noise on the powerline may be unplugged from the powerline, thereby causing the link quality to improve on a segment of the powerline. In either case, the channel access parameters may be adjusted to reflect the change in link quality.

At block 308, node 102 selects a packet from a buffer for transmission over a link. Node 102 may select a packet based on a link quality associated with a channel on which a packet is to be transmitted. For example, node 102 may select larger packets for transmission when a link quality is good (e.g., above a desired threshold of packet error rate (PER)) on the basis that large packets typically use more transmission time and are thus more sensitive to noise than smaller packets. Smaller packets (e.g., below a predefined size requirement) may be selected over larger packets when link quality is comparatively poor. Similarly, link quality may affect the number of packets that are selected for transmission during a transmission cycle. Node 102 may attempt to increase the number of packets transmittted when link quality is considered to have improved.

In addition or alternatively, node 102 may use a combination of one or more other factors to select a packet for transmission. For example, node 102 may use a combination of one or more of buffer priority, buffer length and a deprivation factor to select a packet for transmission. Node 102 may use buffer priority as a factor by selecting packets from a higher priority buffer in favor of packets in a lower priority buffer. Node 102 may use buffer length as a factor in packet selection by favoring selection of packets in buffers having a greater buffer length compared to other buffers. This can have the advantage of freeing buffers at the MAC layer to avoid stalling applications or other network traffic sources at higher layers in the network stack.

Node 102 may use packet deprivation as a factor in packet selection. Generally speaking, packet deprivation is a measure of how long a packet has been waiting to be transmitted. In some embodiments, packets are timestamped with a time that a packet is placed in a buffer for transmission. In such embodiments, the packet deprivation may be determined by comparing the current time with the packet timestamp. In alternative embodiments, packet deprivation may be determined by a counter that is incremented for each transmission cycle that a packet is not transmitted. Node 102 may use the deprivation factor to favor selection of packets that have been waiting to be transmitted for longer times over packets that have been waiting relatively shorter times.

At block 310, node 102 transmits the selected packet. The method may then return to block 302 to process other messages and packets.

It should be noted that in some embodiments, node 102 may scale some or all of the factors described above to influence the effect that the factor has on packet selection. Thus in some embodiments, the factors described above along with scaling factors associated with the selection factors may be applied to packets awaiting transmission on a network. As an example, in some embodiments node 102 may determine a packet selection metric (PSM) for each packet awaiting transmission according to the formula:

PSM=SF1*buffer priority+SF2*buffer length+SF3*deprivation factor+

SF4*link quality

Where SF1, SF2, SF3 and SF4 are scaling factors associated with buffer priority, buffer length, deprivation factor and link quality respectively. Node 102 then selects the packet with the highest packet selection metric for transmission on the network, removes the packet from the buffer it resides in, and adjusts the buffer length accordingly.

Scaling factors for each of the selection factors may be configurable on a global network basis, or on a node by node basis and stored in the configuration data for the node (e.g., configuration data 214, FIG. 2). For instance, scaling factors may be configured for a node based on the type of network traffic the node handles. As an example, a node that is dedicated to processing audio or video data may be configured to use packet selection factors and scaling factors that favor audio or video data.

FIG. 4 is a flow diagram illustrating example operations in a method 400 for determining channel access parameters used in proportionally scheduling packet transmissions. Method 400 begins at block 402 with central coordinator node 120 receiving link quality data from nodes on a network. In addition, central coordinator node 120 may determine link quality for network links coupled to central coordinator 120. As noted above, the link quality may be determined using a signal-to-noise ratio or by comparing actual throughput to expected throughput on a network segment.

At block 404 central coordinator node 120 uses the link quality data to determine channel access parameters for the various links coupled to nodes on the network. For example, central coordinator node 120 may increase channel access duration or channel access priority for links where link quality is considered relatively good and decrease channel access duration or channel access priority when link quality is considered relatively poor. Additionally, central coordinator 120 may provide greater channel access opportunities to nodes having a relatively good link quality compared to other link qualities.

At block 406, the central coordinator sends the channel access parameters determined at block 404 to nodes on the network.

As will be appreciated from the above, the systems and methods of the inventive subject matter dynamically adjust packet transmission scheduling to take into account factors such as link quality, buffer priorities, buffer lengths and deprivation factors to proportionally schedule packet transmission on a network.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

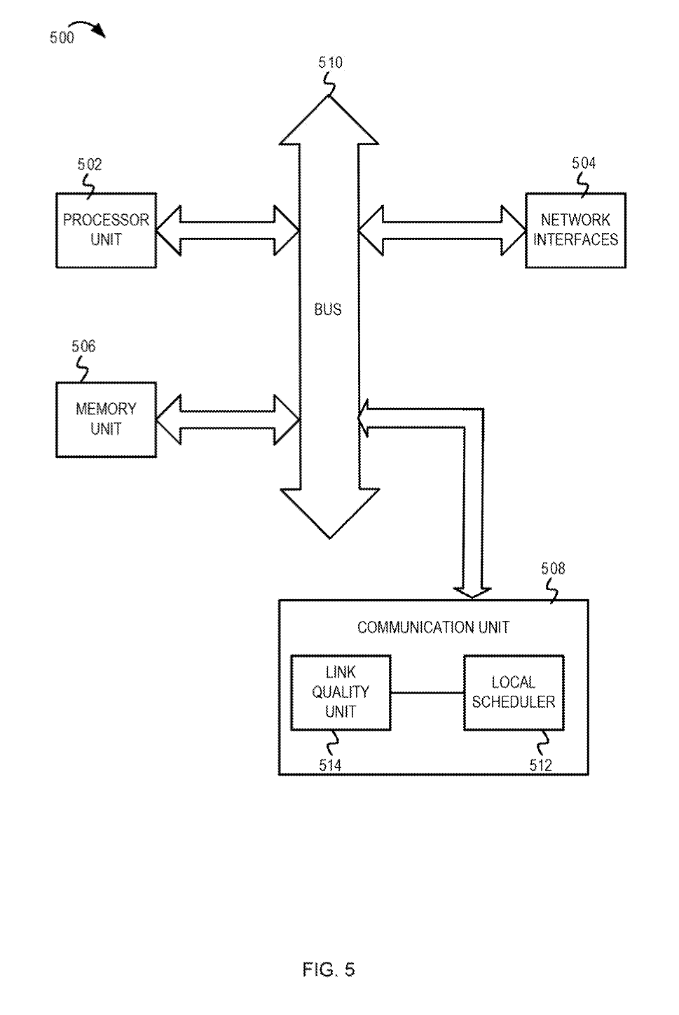

FIG. 5 is a block diagram of one embodiment of an electronic device 500 including a mechanism for determining a network topology in a hybrid communication network. In some implementations, the electronic device 500 may be one of a laptop computer, a netbook, a mobile phone, a powerline communication device, a personal digital assistant (PDA), or other electronic systems comprising a communications unit configured to exchange communications across communication networks. The electronic device 500 includes a processor unit 502 (possibly including multiple processors, multiple cores, multiple nodes, and/or implementing multi-threading, etc.). The electronic device 500 includes a memory unit 506. The memory unit 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 500 also includes a bus 510 (e.g., PCI, ISA, PCI-Express, HyperTransport®, InfiniBand®, NuBus, AHB, AXI, etc.), and one or more network interfaces 504 that may include wireless network interfaces (e.g., a WLAN interface, a Bluetooth® interface, a WiMAX interface, a ZigBee® interface, a Wireless USB interface, etc.) or wired network interfaces (e.g., an Ethernet interface, a powerline communication interface, etc.). In some implementations, the electronic device 500 may support multiple network interfaces—each of which is configured to couple the electronic device 500 to a different communication network.

The electronic device 500 also includes a communication unit 508. The communication unit 508 comprises a link quality unit 512 and a local scheduler unit 514. As described above in FIGS. 1-3, the communication unit 508 implements functionality to proportionally schedule packet transmissions in a communication network. Any one of these functionalities may be partially (or entirely) implemented in hardware and/or on the processor unit 502. For example, the functionality may be implemented with an application specific integrated circuit, in logic implemented in the processor unit 502, in a co-processor on a peripheral device or card, etc. Further, realizations may include fewer or additional components not illustrated in FIG. 5 (e.g., video cards, audio cards, additional network interfaces, peripheral devices, etc.). The processor unit 502, the memory unit 506, and the network interfaces 504 are coupled to the bus 510. Although illustrated as being coupled to the bus 510, the memory unit 506 may be coupled to the processor unit 502.

While the embodiments are described with reference to various implementations and exploitations, it will be understood that these embodiments are illustrative and that the scope of the inventive subject matter is not limited to them. In general, techniques for proportionally scheduling packet transmissions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
maintaining a plurality of buffers configured to store packets to be transmitted on a network, each buffer of the plurality of buffers having a buffer priority and a buffer length;
receiving one or more channel access parameters, the one or more channel access parameters determined in accordance with a link quality between nodes on the network; and
selecting a packet to be transmitted from a buffer of the plurality of buffers based on the channel access parameters and one or more of the buffer priority of the buffer, the buffer length of the buffer and a deprivation factor associated with the packet.

2. The method of claim 1, wherein the one or more channel access parameters include a channel access duration.

3. The method of claim of claim 1, further comprising applying a scaling factor to one or more of the buffer priority, the buffer length and the deprivation factor.

4. The method of claim 1, wherein the network is a powerline network.

5. A method comprising:
receiving a link quality data for one or more network links communicably coupling nodes on a network;
determining based on the link quality data one or more channel access parameters for the one or more network links; and
sending the channel access parameters to the nodes on the network.

6. The method of claim 5, wherein determining based on the link quality data one or more channel access parameters includes determining a channel access duration for a link.

7. The method of claim 6, and further comprising increasing the channel access duration for the link in response to determining an increased link quality.

8. The method of claim 5, wherein determining based on the link quality data one or more channel access parameters includes determining one or more channel access opportunities for a link.

9. The method of claim 8, and further comprising increasing the channel access opportunities for the link in response to determining an increased link quality.

10. The method of claim 5, wherein the link quality data is determined according to signal-to-noise ratios associated with the one or more network links.

11. One or more machine-readable media having stored thereon machine executable instructions, which when executed by one or more processors causes the one or more processors to perform operations that comprise:
maintaining a plurality of buffers configured to store packets to be transmitted on a network, each buffer of the plurality of buffers having a buffer priority and a buffer length;
receiving one or more channel access parameters, the one or more channel access parameters determined in accordance with a link quality between nodes on the network; and
selecting a packet to be transmitted from a buffer of the plurality of buffers based on the channel access parameters and one or more of the buffer priority of the buffer, the buffer length of the buffer and a deprivation factor associated with the packet.

12. The one or more machine-readable media of claim 11, wherein the one or more channel access parameters include a channel access duration.

13. The one or more machine-readable media of claim 11, wherein the operations further comprise applying a scaling factor to one or more of the buffer priority, the buffer length and the deprivation factor.

14. One or more machine-readable media having stored thereon machine executable instructions, which when executed by one or more processors causes the one or more processors to perform operations that comprise:
receiving link quality data for one or more network links communicably coupling nodes on a network;
determining based on the link quality data one or more channel access parameters for the one or more network links; and
sending the channel access parameters to the nodes on the network.

15. The one or more machine-readable media of claim 14, wherein the one or more channel access parameters include a channel access duration.

16. The one or more machine-readable media of claim 15, wherein the operations further comprise increasing the channel access duration in response to determining an increased link quality.

17. The one or more machine-readable media of claim 14, wherein the one or more channel access parameters include one or more channel access opportunities.

18. The one or more machine-readable media of claim 17, wherein the operations further comprise increasing the one or more channel access opportunities in response to determining an increased link quality.

19. The one or more machine-readable media of claim 14, wherein the link quality data is determined according to signal-to-noise ratios associated with the one or more network links.

20. A device comprising:
a scheduler to:
maintain a plurality of buffers configured to store packets to be transmitted on a network, each buffer of the plurality of buffers having a buffer priority and a buffer length;
receive one or more channel access parameters, the one or more channel access parameters determined in accordance with a link quality between the nodes on the network; and
select a packet to be transmitted from a buffer of the plurality of buffers based on the channel access parameters and one or more of the buffer priority of the buffer, the buffer length of the buffer and a deprivation factor associated with the packet.

21. The device of claim 20, wherein the one or more channel access parameters include a channel access duration.

22. The device of claim 20, wherein the scheduler is further to apply a scaling factor to one or more of the buffer priority, the buffer length and the deprivation factor.

23. The device of claim 20, wherein the network is a powerline network.

24. A coordinator node comprising:
a scheduler to:
receive link quality data for one or more network links communicably coupling nodes on a network;
determine based on the link quality data one or more channel access parameters for the one or more network links; and
send the channel access parameters to the nodes on the network.

25. The coordinator node of claim 24, wherein the one or more channel access parameters include a channel access duration for a link.

26. The coordinator node of claim 25, wherein the scheduler is further configured to increase the channel access duration for the link in response to determination of an increased link quality.

27. The coordinator node of claim 24, wherein the one or more channel access parameters include one or more channel access opportunities for the link.

28. The coordinator node of claim 27, wherein the scheduler is further configured to increase the channel access opportunities for the link in response to determination of an increased link quality.

29. The coordinator node of claim 24, wherein the link quality data is determined according to signal-to-noise ratios associated with the one or more network links.
